(19) United States
(12) Patent Application Publication
(10) Pub. No.: US 2005/0289572 A1
(43) Pub. Date: Dec. 29, 2005

(54) External optical storage device having a dustproof cover

(75) Inventors: Yi Fen Chen, Taipei (TW); Shen-Feng Huang, Taipei (TW)

Correspondence Address: G. LINK CO., LTD, 3550 Bell Road, Minooka, IL, 60447, US

(73) Assignee: BEHAVIOR TECH COMPUTER CORP.

(21) Appl. No.: 11/008,323

(22) Filed: Dec. 10, 2004

(30) Foreign Application Priority Data
Jun. 25, 2004 (TW) 093210076

(51) Int. Cl. G11B 33/14

(52) U.S. Cl. 720/648

(57) ABSTRACT

The present invention discloses an external optical storage device having a dustproof cover comprising an internal optical storage device and an external enclosure. The optical storage device has at least one slot on its panel, and the external enclosure comprises a box body, a front cover, and a dustproof cover. The box body is a structure in the shape of a box and has an interior space for containing and installing the internal optical storage device. The front cover is hollow and disposed at the front panel of the box body, and the dustproof cover is disposed on the front cover at the position in front of the slot. If the internal optical storage device is not in use, the dustproof cover seals the slot and if the internal optical storage device is in use, the dustproof cover can be lifted to expose the slot.

### FIELD OF THE INVENTION

The present invention relates to an external optical storage device, more particularly to an external optical storage device having a dustproof cover.

### BACKGROUND OF THE INVENTION

FIG. 1 shows an illustrative view of the structure of a conventional external enclosure for an internal optical storage device. The conventional external enclosure 10 is a square box and has an interior space for containing and installing an internal optical storage device (such as an internal CD-ROM drive) and an opening 10a disposed at the front of the enclosure 10 is fully exposed from the front panel of the internal optical storage device. Therefore, such conventional external enclosure 10 is not applicable for a panel with a small opening area of the internal optical storage device.

In view of the shortcomings of the prior art, the inventor of the present invention thought of a way to improve the external enclosure for the internal optical storage device having an opening on its front panel.

### SUMMARY OF THE INVENTION

Therefore, the primary objective of the present invention is to provide an external optical storage device having a dustproof cover.

The secondary objective of the present invention is to provide an external enclosure having a dustproof cover for an internal optical storage device having a slot disposed on its front panel, and assemble the internal optical storage device together with the external enclosure to produce an external optical storage device having a dustproof cover.

To achieve the foregoing objectives, the present invention provides an external optical storage device having a dustproof cover, which comprises: an internal optical storage device with at least one slot on its panel; an external enclosure comprises a box body being a box structure and having an interior space for containing and installing the internal optical storage device; a front cover being hollow and disposed at the front panel of the box body; and a dustproof cover being disposed on the front cover at the position in front of the slot, such that if the internal optical storage device is not in use, the dustproof cover seals the slot, and if the internal optical storage device is in use, the dustproof cover can be lifted to expose the slot.

### BRIEF DESCRIPTION OF THE DRAWINGS

The above objects and advantages of the present invention will become more apparent with reference to the appended drawings wherein:

FIG. 1 is an illustrative view of the structure of a conventional external enclosure structure for an internal optical storage device;

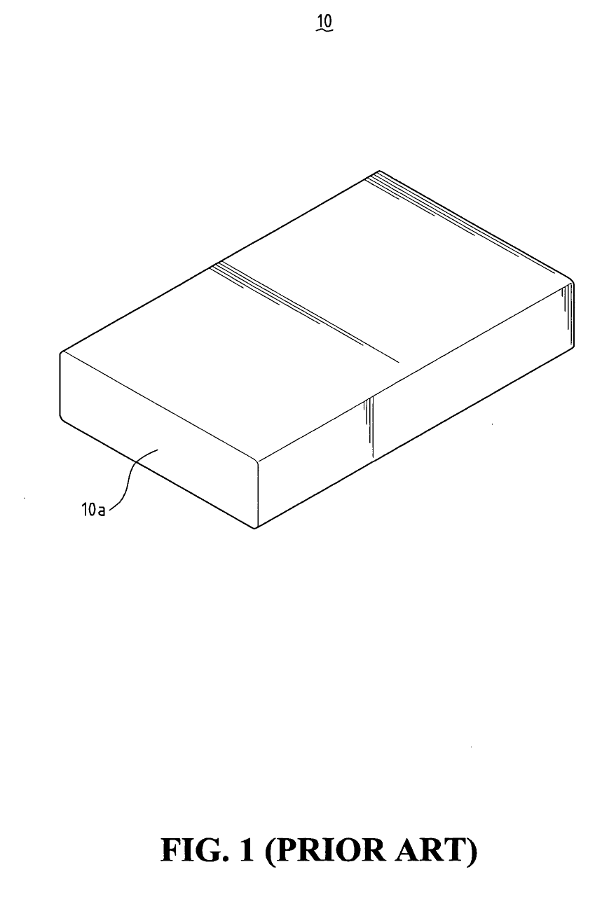

FIG. 2 is a perspective view of an external optical storage device with its dustproof cover lifted according to the present invention;

FIG. 3 is a perspective view of an external optical storage device with its dustproof cover closed according to the present invention;

FIG. 4 is an exploded view of an external optical storage device according to the present invention;

FIG. 5 is a view of the structure of an external connection box according to the present invention; and

FIG. 6 is a view of the structure of a dustproof cover according to the present invention.

### DETAILED DESCRIPTION OF THE INVENTION

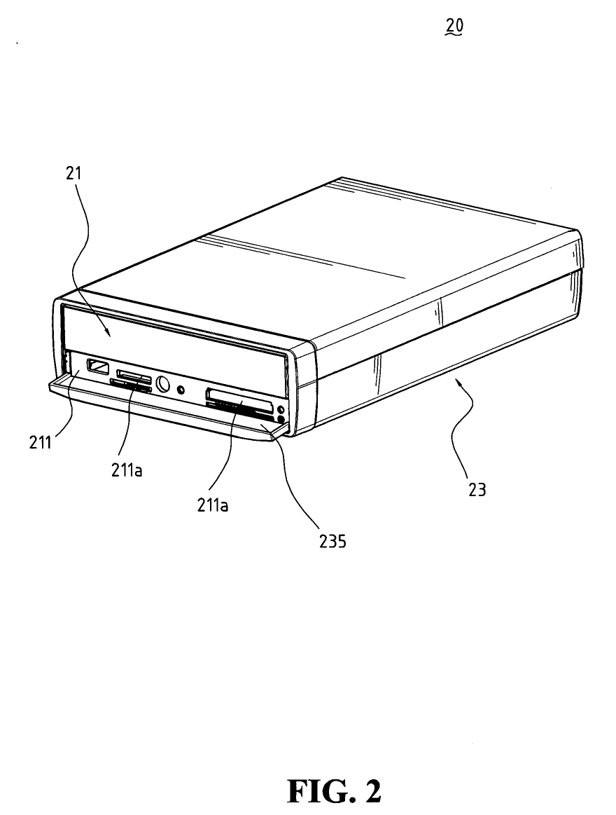

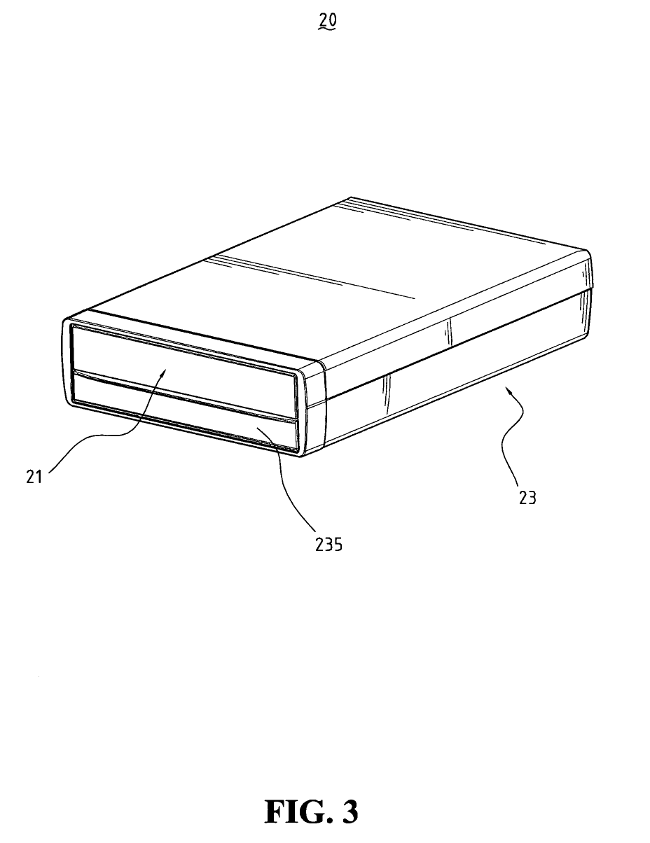

FIG. 2 shows a perspective view of the external optical storage device with its dustproof cover lifted according to the present invention and FIG. 3 shows the perspective view of the external optical storage device with its dustproof cover closed according to the present invention. Since the external optical storage device 20 of the invention adopts the design of a liftable dustproof cover 235, therefore it can protect an internal optical storage device 21 when it is not in use and prevent foreign matters including dusts and particles entering the internal optical storage device 21 from the slot 211a of the front panel 211. If the internal optical storage device 21 is in use, the dustproof cover 235 is lifted to expose the slot 211a.

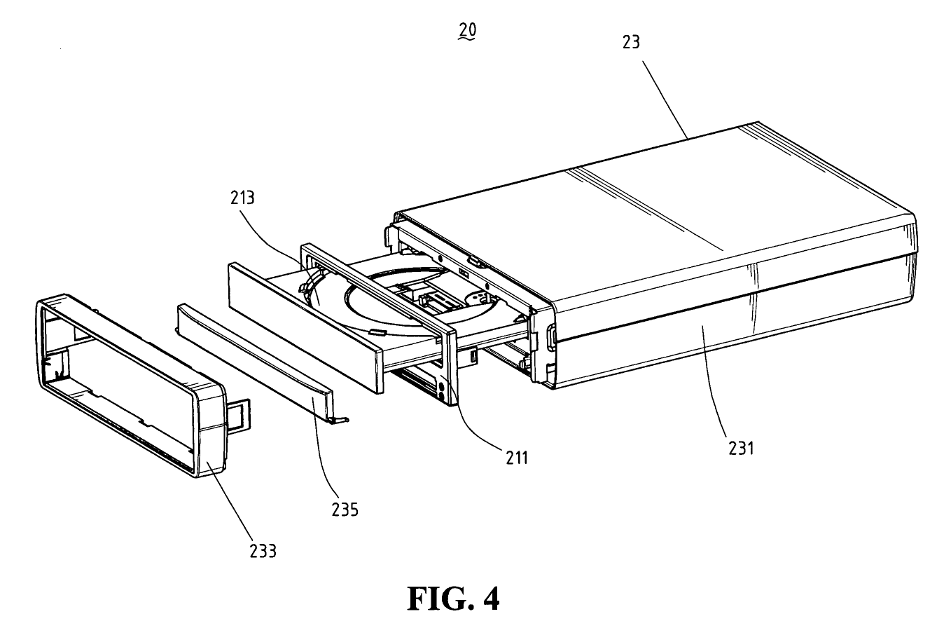

FIG. 4 shows an exploded view of an external optical storage device according to the present invention. The external optical storage device 20 of the present invention comprises an internal optical storage device 21 and an external enclosure 23; wherein the internal optical storage device 21 is installed and contained in the interior space of the external enclosure 23. The front panel 211 of the internal optical storage device 21 installs at least one slot 211a, and the slot 211a is used for receiving the insertion of a CF memory card, a SD memory card, and a XD memory card, etc and connecting such cards into the corresponding memory card slots in the internal optical storage device 21. The slot 211a also could be used for receiving the insertion of a USB connector, an IEEE1394 connector, and a USB pen drive, etc and connecting such connectors or pen drive to the corresponding USB socket and IEEE1394 sockets in the internal optical storage device 21. The main function of these slots 211a is to receive the insertion of an electronic device and allow an electronic device to be electrically connected to the internal optical storage device 21. The external enclosure 23 is preferably applicable for the internal optical storage device 21 of the same sort. For example, if the internal optical storage device 21 is an internal optical disk drive, regardless of a standard drive or a half-height drive, the external enclosure 23 will be designed to accommodate and install an internal optical disk drive of different lengths. When the external optical storage device 20 of the invention is installed, the internal optical storage device 21 is contained and installed in the box body 231 first, and then the front cover 233 of the dustproof cover 235 is installed and mounted to the front of the box body 231.

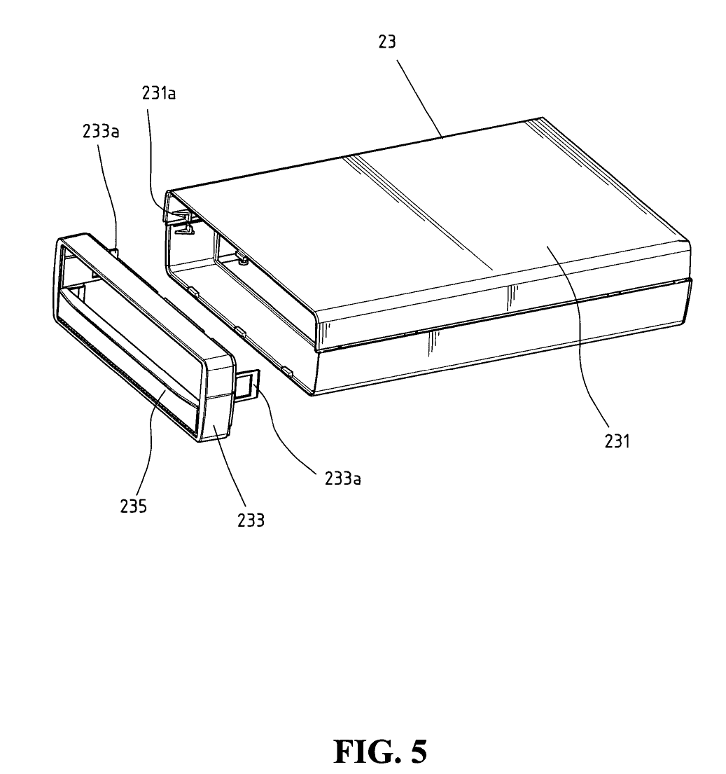

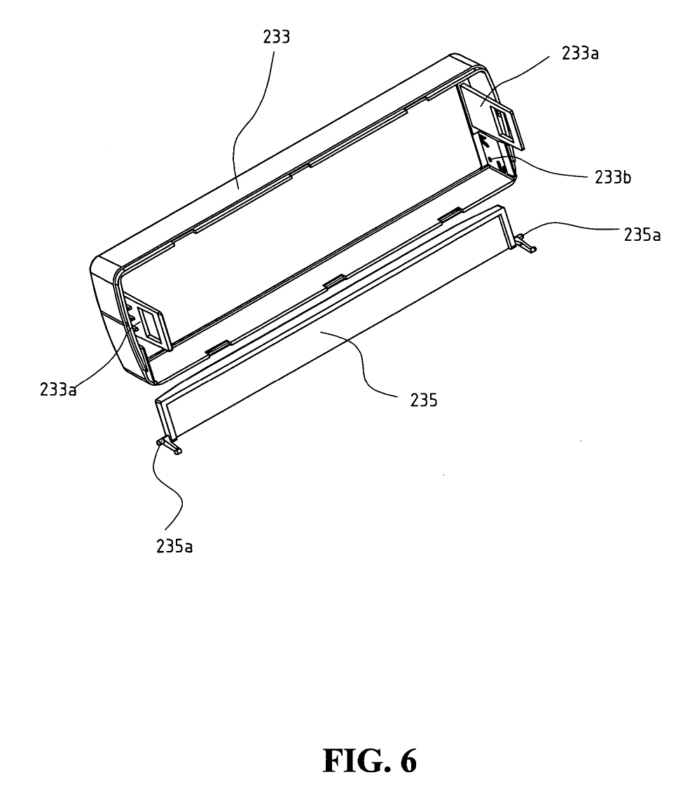

FIG. 5 shows a view of the structure of an external enclosure according to the present invention and FIG. 6 shows a view of the structure of a front cover and a dustproof cover according to the present invention. The external enclosure 23 comprises a box body 231, a front cover 233, and a dustproof cover 235. The box body 231 is a box structure, and the interior space of the box body 231 is used for containing and installing an internal optical storage device 21. The front cover 233 is a hollow structure and the front cover 233 is installed at the front end of the box body 231 and disposed in front of the front panel 211. The space at the upper half of the front cover 233 is provided for a tray 213 of the internal optical storage device 21 to load or eject an optical disk, and the space at the lower half is used for installing the dustproof cover 235. An ear section 233a is installed on both sides of the front cover 233, and the ear sections 233a on both sides are extended into the box body 231 and mounted onto a latch section 231a of the box body 231. An insert pin 235a is disposed each on both sides of the dustproof cover 235, and the insert pin 235a is inserted into an insert pin hole 233b of the front cover 233.

The box body 231 is made of a metal material or a plastic material; similarly, the front cover 233 and the dustproof cover 235 are made of a metal material or a plastic material.

The external optical storage device 20 of the present invention provides multiple functions. Besides the functions of reading or writing an optical medium (such as a CD or a DVD), it also can access a memory card, a USB electronic device and an IEEE1394 device. In the meantime, the design of the external optical storage device 20 having a dustproof cover 235 can be used together with the internal optical storage device 21 having a slot 211a on its front panel 211, and thus adding a function of protecting the internal optical storage device. 21.

While the invention has been described by way of examples and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

1. An external optical storage device having dustproof cover, comprising:
an internal optical storage device, having at least one front panel, and said front panel having at least one slot;
an external enclosure, being a box structure and having:
an interior space for containing and installing said internal optical storage device;
a front cover, being a hollow structure and disposed at a box body in front of said front panel; and
a dustproof cover, being disposed on said front cover corresponding to the position in front of said slot;
thereby, if said internal optical storage device is not in use, said dustproof cover seals said slot, and if said internal optical storage device is in use, said dustproof cover is lifted to expose said slot.

2. The external optical storage device having dustproof cover according to claim 1, wherein said dustproof cover on both sides comprises an insert pin being inserted into said front cover.

3. The external optical storage device having dustproof cover according to claim 2, wherein said front cover comprises two insert pin holes for receiving said two corresponding insert pins.

4. The external optical storage device having dustproof cover according to claim 1, wherein said front cover comprises an ear section on both sides.

5. The external optical storage device having dustproof cover according to claim 4, wherein said box body comprises two latch sections for mounting said two corresponding ear sections.

6. The external optical storage device having dustproof cover according to claim 1, wherein said slot is used for receiving the insertion of a memory card.

7. The external optical storage device having dustproof cover according to claim 1, wherein said slot is used for receiving the insertion of a USB connector.

8. The external optical storage device having dustproof cover according to claim 1, wherein said slot is used for receiving the insertion of an IEEE1394 connector.

9. The external optical storage device having dustproof cover according to claim 1, wherein said slot is used for receiving the insertion of an electronic device, such that said electronic device is electrically coupled to said internal optical storage device.

10. The external optical storage device having dustproof cover according to claim 1, wherein said internal optical storage device is an internal optical disk drive.

11. The external optical storage device having dustproof cover according to claim 10, wherein said internal optical disk drive is an internal half-height optical disk drive.

12. The external optical storage device having dustproof cover according to claim 10, wherein said built-in optical disk drive is an internal standard optical disk drive.

13. The external optical storage device having dustproof cover according to claim 1, wherein said box body is made of one selected from the collection of a metal material and a plastic material.

14. The external optical storage device having dustproof cover according to claim 1, wherein said front cover is made of one selected from the collection of a metal material and a plastic material.

15. The external optical storage device having dustproof cover according to claim 1, wherein said dustproof cover is made of one selected from the collection of a metal material and a plastic material.
